(19) United States
(12) Patent Application Publication
(10) Pub. No.: US 2009/0020212 A1
(43) Pub. Date: Jan. 22, 2009

(54) SMART COMPOSITES AND METHOD OF USE THEREOF

(76) Inventor: Anthony Cacace, Haddam, CT (US)

Correspondence Address: ARENT FOX LLP, 1050 CONNECTICUT AVENUE, N.W., SUITE 400, WASHINGTON, DC, 20036, US

(21) Appl. No.: 12/123,155

(22) Filed: May 19, 2008

Related U.S. Application Data
(60) Provisional application No. 60/924,524, filed on May 18, 2007.

(51) Int. Cl. B32B 38/00; B32B 37/00; G01M 19/00

(52) U.S. Cl. 156/64; 156/60; 73/865.8

(57) ABSTRACT

Devices, systems, and methods for monitoring the condition of components, such as components of airframes, and in particular devices, methods, and systems for detecting faults and warning of faults in components using transmission mechanisms, such as optically or electrically conductive material incorporated in the construction of the components, added to a laminate material.

This application is based upon and claims the benefit of priority from the prior U.S. Provisional Application No. 60/924,524 filed on May 18, 2007, titled SMART COMPOSITES AND METHOD OF USE THEREOF, the entire contents of which are incorporated herein by reference.

### BACKGROUND OF THE INVENTION

1. Field of the Invention

The present invention relates to devices, systems, and methods for monitoring the condition of components, such as components of airframes, and in particular to devices, methods, and systems for detecting faults and warning of faults in components.

2. Background of the Related Art

A problem exists in the prior art in that critical and other components, such as components of airframes, may fail unexpectedly and without detection, such as may occur during routine operation, inspection or maintenance. There remains an unmet need for devices, systems, and methods for improving the detection and provision of alerts regarding failures in such components.

### SUMMARY OF THE INVENTION

Aspects of the present invention overcome these problems, and others, by providing devices, systems, and methods for monitoring components by monitoring critical points in fabric, laminate composites, and other elements comprising these components. For example, critical points may be monitored by including an optically or electrically conductive material within the fabric or other material used to construct such a critical point. Through monitoring at least one transmission parameter associated with the conductive material, the critical point may be monitored for weaknesses and faults.

Additional advantages and novel features of aspects of the present invention will be set forth in part in the description that follows, and in part will become more apparent to those skilled in the art upon examination of the following or upon learning by practice thereof.

### BRIEF DESCRIPTION OF THE FIGURES

In the drawings:

FIG. 1 shows a representative grid of conductive traces embedded in the fabric for a laminated portion of a component, in accordance with one embodiment of the present invention;

FIG. 2 shows a representative grid of traces located between two laminate layers for a component, prior to completion of the laminate process, in accordance with an embodiment of the present invention;

FIG. 3 is a representative diagram of the grid of traces embedded between the laminate layers as shown in FIG. 2, following completion of the laminate process;

FIG. 4 is a cross-sectional view of a portion of a laminated component in the process of laminate layers being added, in accordance with an embodiment of the present invention.

FIG. 5 shows a conductor sprayed-on flexible substrate usable in accordance with aspects of the present invention;

### DETAILED DESCRIPTION OF THE INVENTION

An aspect of the present invention provides devices, systems, and methods for monitoring components by monitoring critical points in fabric or other elements comprising these components. For example, such fabric or other elements may make up laminates used to form aircraft components. In one exemplary aspect, critical points are monitored by implanting, such as by weaving or otherwise embedding, transmission mechanisms, such as fiber optic or electrically conductive material within the fabric used to construct laminate for constructing the critical point. In another exemplary aspect, a sprayed-on or otherwise applied conductive material is added to the laminate material (e.g., sprayed onto a layer of fabric), so as to allow conductive heating of the composite material containing the laminate with the applied conductive material.

Following embedding, transmissions through the transmission mechanism are used to detect potential faults at the critical points. For example, in accordance with one aspect, breaks or other weaknesses in the component produce breaks in the transmission mechanism (e.g., the fiber optic line woven into the laminate is broken by a crack forming in the laminate), and the breaks in the transmission mechanism allow an altered signal to be produced, indicating the presence of the fault. In accordance with one aspect, regular or continuous transmission occurs via the transmission mechanism, and a failure of transmission indicates the possible presence of a fault in the component.

In addition to such faults as physical breaks in the components monitored, aspects of the present invention provide devices methods and system for testing and detecting additional faults. For example, in one aspect, non-destructive testing (NDI) to determine condition of a part may be utilized. In this accordance with this aspect, the fabric-based or other transmission-based additions to the component are completed. At the factory or elsewhere prior to final installation or operation, a benchmark of the transmission mechanism is obtained.

For example, if fabric-based circuitry is added to the component, an inherent resistance and/or inductance exists for the component prior to use. This inherent resistance and/or inductance of the circuitry (referred to herein for this example as the “benchmark”) reflects unbroken and unstressed circuitry and can be determined, for example, by applying a voltage across the circuitry. After installation and/or use of the component (e.g., after certain intervals of operation of the aircraft of which the part may be a component), the voltage can be applied to the circuitry again to determine if the resistance and/or inductance is altered. This NDI result relates to the condition of the component to which the circuitry is attached. A significant change in resistance, for example, may reflect a crack in the component or part that has created open portions of the circuitry. Similar results may be determined using optical fibers and transmissions there through.

In accordance with one aspect, the benchmark parameters may be physically indicated on the part or otherwise associated with the part to simplify testing.

In accordance with another aspect, a voltage or other input for obtaining part health measurement (e.g., optical signal through fiber optic lines) is continuously or periodically provided to the circuitry while in operation, so that continuous or semi-continuous monitoring can be obtained. Thus, for example, the aircraft in which the part is installed could include warning lights, such that if the parameters of the circuitry change more than a predetermined amount (e.g., if resistance changes by more than 1%), a warning light may be triggered in a visible location for the pilot. The triggering may be accomplished using standard circuit components, and/or a processor onboard the aircraft, and electrical power of the aircraft, each connected to or otherwise communicating with the component embedded circuitry. Each component may optionally have a separate warning light, such that a warning that a tail component, wing component, or other structural component, among others, is specifically indicated.

In another aspect, the circuit includes printed circuit elements capable of determining disengagement of laminate portions (e.g., by showing an inductance change due to a gap forming between the laminate portions).

In yet another aspect, detection of a component failure may trigger a response action, such as applying an adhesive or sealant to the damaged location. For example, very small bulbs of uncured resin could be embedded in the component, and the bulbs triggerably ruptured upon damage being determined to have occurred. The released resin would then cure and repair the damaged location.

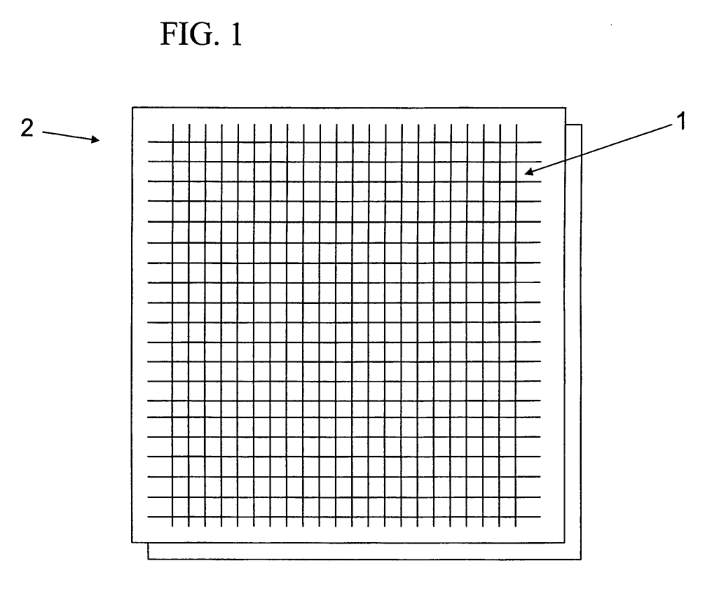

FIGS. 1-4 present exemplary representations of components and features in accordance with embodiments of the present invention. FIG. 1 shows a representative grid of conductive traces 1 (similarly, conductive material sprayed onto a fabric contained in a layer of a composite, or optical fibers, for example, could be used in lieu of a grid of conductive traces) embedded in the fabric 2 for a laminated portion of a component, in accordance with one aspect of the present invention. For example, the traces 1 may be interwoven with the non-trace fibers of the fabric 2. The conductive traces 1 may comprise, for example, very thin wires that are able to conduct electricity. Rupture of a trace will thus reduce its ability to conduct electricity and/or otherwise affect the capability of the overall grid to conduct electricity.

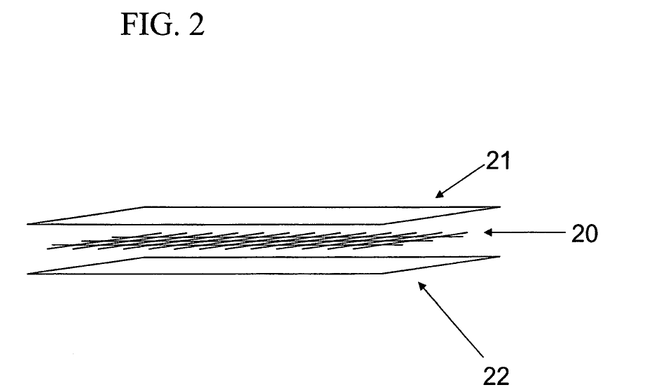

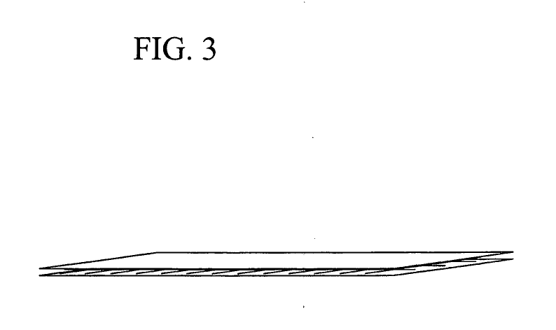

FIG. 2 shows a representative grid of traces 20 located between two laminate layers 21 and 22 of a component, prior to completion of the laminate process. FIG. 3 is a representative diagram of the sandwiched grid of traces of FIG. 2 embedded between the laminate layers 21 and 22, following completion of the laminate process.

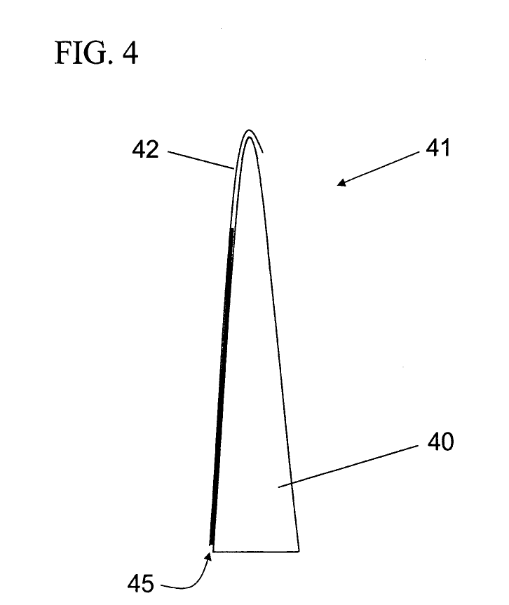

FIG. 4 is a cross-sectional view of a portion of a laminated component in the process of laminate layers being added. As shown in FIG. 4, a first part 40 of the laminated component 41 has been formed. In FIG. 4, a laminated layer in the process of being added 42 has been placed over a conductive grid 45 located between the formed component 40 and the added layer 42.

Various implementations of the present invention may include placing the conductive traces or conductive material selectively located within multi-levels in a resulting composite component.

In one variation, certain conductive material or portions thereof are selectively located at differing levels in the multi-level laminated composite product, so as to provide sufficient monitoring capability, but so as to retain, to the extent possible, the profile and other characteristics of the part to be monitored (e.g., so as not to affect, or so as to minimally affect surface characteristics of the monitored part). Variations of the present invention may use various circuit elements incorporable into the composite product, so as to deliver electrical, optical, or other input to the appropriate surface area.

For example, the conductive traces or conductive material may be located at the innermost surface of the part, also referred to interchangeably herein as the inner-mold surface (IML). In this configuration, within the in-mold production of the product, a plug may be incorporated into the conductive material and protected through the Resin Transfer Molding (RTM) process, in a fashion such that, when molding is completed, the product is completely functional, and the component is removed from the mold ready to be connected to a power and control source.

One variation further includes an insulated plug assembly incorporated into the molded and/or otherwise formed component or part. The incorporated plug assembly includes connections that are preserved during composite manufacture, such as during the RTM process. In one variation, a recess is created in a mandrel that is used to produce the inner molding surface of the part being created (e.g., by lamination), and a specially designed tool is used to generate a cover plug (e.g., comprising a flexible material, such as silicon) and an insert into the electrical plug to occupy the recess. During composite manufacture, the part is heated, and the cover plug expanded to seal against the resin of the laminate. This seal comprises a material that can withstand the pressure used to form the composite product (e.g., greater than 100 psi). Among other advantages, this approach prevents laminate resin or other product formation materials from entering the formed plug and damaging the plug's intended operation. After manufacture is completed, the mold is disassembled, and the cover plug and insert removed. The remaining components, after removal of the plug and insert, form an electrical or optical connector for connecting power and/or control components to the conductive element of the product.

In one implementation of the connector, wires or other connection features extend from the formed electrical connector, and wires or other connection features extend from the incorporated conductive element, such as at one end portion of the formed component. The connection features of the cover plug and the conductive element may be connected (e.g., by welding) at the end portion of the formed component.

In another implementation, a metal or other electrical or optical conductor element may be sprayed onto a flexible substrate and used to provide the monitoring function, the conductor sprayed-on flexible substrate being capable of withstanding the heat and pressure of the laminate process and thereby usable to form a layer of the composite product. The substrate typically has a patterned shape and comprises a fabric, such that the substrate with the sprayed-on conductor forms a resistor circuit via the pattern of the substrate and the sprayed-on conductor.

In one variation of the present invention, the substrate with sprayed-on conductor is rectilinear; in another variation, the substrate with sprayed-on conductor is triangular and has conductor material on two surfaces (e.g., such that differing resistance is provided on each surface). In some variations, the substrate with sprayed-on conductor is in a pattern forming circuit elements generally oriented in one direction on the surface of the monitoring element. In one variation of these implementations, the resistance varies in a direction perpendicular to the orientation of the circuit elements; in another variation, the resistance varies in the direction of the circuit elements. Generally, depending on how the conductor material is sprayed on, a wide range in variation of performance may be obtained.

In one variation, rather than using a conductor sprayed-on flexible substrate that has been bonded and sealed for use in existing applications, such as a helicopter blade, the dry, unbonded and unsealed, flexible substrate (e.g., fabric) with the sprayed-on conductor, is incorporated into the laminate process so as to form a layer within a composite product. This conductive layer may be selectively incorporated into any layer (also interchangeably referred to herein as a “ply”) in the laminate process, such that the conductive element may be selectively located closer or further from the surface of the component, to thereby selectively further control electrical or optical conduction to the component. Thus, selectively, one or more non-conductive material incorporated layers may be found between the conductive material incorporated layer and the surface of the component.

In one exemplary variation, a component or part, such as a jet engine turbine airfoil, may be formed by a plurality of plies using a Reaction Injection Molding (RIM) process. The plies are shaped, typically one layer at a time, to form the part, for example, using a mandrel. One of the ply layers, for example, placed near the surface of the part to be formed, contains the conductive element, and this layer is formed into the plurality of layers so as to encapsulate the conductive element fabric and sprayed on conductor material without any significant shear concerns within the produced part.

Preforming and/or consolidation of multiple plies of composite material in devices or methods incorporating aspects of the present invention may also be accomplished by hand or using a mandrel or other device, such as the device described in U.S. patent application Ser. No. 11/808,925 filed on Jun. 13, 2007, titled DEVICE FOR PREFORMING CONSOLIDATION AND METHOD OF USE THEREOF, the entire contents of which are incorporated herein by reference.

In a variation of the present invention, each of a plurality of conductive elements are individually controllable, such that electrical or optical input is transmitted to selected areas of the composite component only as needed (e.g., monitoring is cycled among conductive components). Among other advantages, this approach minimizes the amount of power used by the composite component at any time.

In some implementations, each of the conductive elements is located in a different layer of the composite structure. In addition to performance reasons for the differing conductive element locations, multiple layer design provides redundancy for the system.

In variations of the present invention, two or more connectors may be attached to the conductive element layer, such that power may be transmitted to the conductor so as to produce and transmit an electrical or optical signal in the conductive element layer. For example, in one variation, the conductors are connected to and extend from one end of the conductive element, and may be bent or otherwise manipulated so as to be coupled to a connector (e.g., bent around the intervening non-conductive element layers so as to be attached to a connector formed within or near the inner surface of the part).

In one variation, the recess for containing the cover plug and insert is alternatively referred to as a “plug set.” A problem with forming composite parts is how to create a selectively engaged connector for the part that is both placed in a specific location and survives the composite part formation process, which often involves high pressures, temperatures, and dissemination of resin materials that can adversely impact electrical connections.

In one variation of the present invention, these problems, as well as others, are solved through the use of a plug set and a buffer material, such as silicone, to encapsulate the plug set, along with the design of a mandrel that allows both the formation of the part and incorporation of the bumper. The buffer material seals the plug set against possible intrusion of materials used to form the composite structure and other impacts of the part formation process.

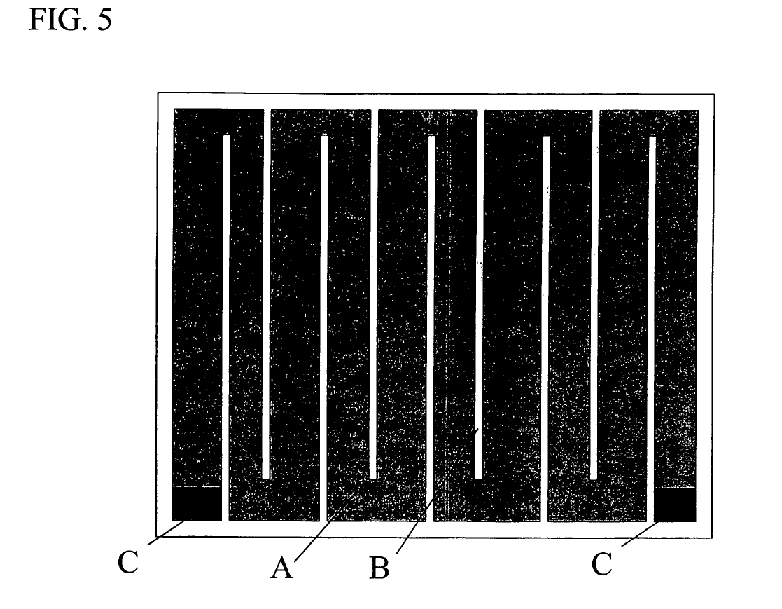

Illustrative formation of an exemplary part, in accordance with an embodiment of the present invention using the attached figures will now be described. FIG. 5 shows a conductor sprayed-on flexible substrate usable with the present invention. As shown in FIG. 5, circuit portions A are formed by conductor sprayed on the material, and areas free of conductor B separate the circuit portions. Connector attachment portions C are also formed on the substrate.

Several variations of connection features and methods for connecting the wires from the plug and wire set to the conductor sprayed-on flexible substrate or to a printed circuit type flexible substrate. In each of these variations, generally, a conductor portion from the wire set extending past the end of the composite layers is folded over and welded, soldered, or otherwise connected to the connector attachment portions of the flexible substrate for the conductive component layer.

Additional layers of composite material and conductive portion flexible substrate are similarly added to the composite product to form subsequent layers and to build the product to a desired wall thickness.

The layers and mandrel when assembled are then placed into a mold, and resin is injected to complete the composite product formation.

In other variations of the present invention, rather than folding and connecting the wires to conductive elements via folding about the end of the layers during formation of the product, connection is made to the conductive elements after formation of the composite product via insertion of connecting elements through cut, drilled, or otherwise formed openings in the product.

Connection via such openings may be made using various plating techniques, for example, such as as electroless copper plating, periodical reverse plating, direct current plating, or other processes for plating through-holes. Alternatively, rivets or other heat conducting components may be inserted into the openings and then heated and soldered to ensure a connection is completed to the conductive element layers. Connection points from the conductive elements may also be located at different cross-sectional locations for different layers; this approach allows different connections to be made to different conductive materials on different levels.

In one variation for connecting to the conductive elements for aspects of the invention using the conductor sprayed-on flexible substrate, midway through the lamination process, a connection pad is attached to the substrate. After product formation is completed, composite layers covering the connection pad are ground down or otherwise removed, such as by skiving, to allow solder or other connection to the pad.

Aspects of the present invention further include flexible circuit components for connecting to the conductive elements, such as via plug-in contact to form a connection. For example, rivet connections to the conductive elements may include connection pins or pin connections, or be otherwise connectable to a plug-in circuit board. In some variations, the component containing the conductive elements and the plug-in circuit board are joined using an adhesive (e.g., film adhesive silicone) to seal the connected parts. Among other things, such plug-in connection eases component assembly and replacement.

Several additional variations of features and methods exist for producing such post-product formation connections. Connections are made, in some variations, using soldering, plating, or welding, among other methods

Connectors to the conductive grid or optically conductive material may include connectors using numerous pins or individual wires, and/or using connectors incorporating aspects of the connectors described in U.S. Provisional Application No. 60/929,428 filed on Jun. 27, 2007, titled IN-SITU ELECTRICAL CONNECTOR WITH COMPOSITE STRUCTURE and U.S. application Ser. No. 12/076,977 filed on Mar. 26, 2008, titled CONNECTOR USEABLE WITH MULTIPLE LAYERED CONNECTIONS AND METHOD OF USE THEREOF, the entire contents of each of which are incorporated herein by reference.

Although exemplary embodiments of the present invention have now been discussed in accordance with the above advantages, it will be appreciated by one of ordinary skill in the art that these examples are merely illustrative of the invention and that numerous variations and/or modifications may be made without departing from the spirit or scope invention.

We claim:

1. A device for detecting faults and weaknesses in a component, the device comprising:
a non-conductive material shaped to form the component; and
a monitoring module including:
a conductive material in contact with the non-conductive material;
an input for inputting one of an electrical and an optical signal into the conductive material; and
a detector that detects at least one transmission parameter of the conductive material based on a received signal after the signal has been conducted through the conductive material and determines whether a weakness exists in the component based on the at least one transmission parameter.

2. The device according to claim 1, wherein the detector determines that a weakness exists based on at least one of a change in the at least one transmission parameter and a deviation of the at least one transmission parameter from a predetermined standard.

3. The device according to claim 2, wherein the non-conductive material includes a composite laminate, and wherein the conductive material is sandwiched between two layers of non-conductive material.

4. The device according to claim 3, further comprising:
a plurality of sections of uncured resin embedded in at least one layer of the composite laminate, wherein the plurality of sections are configured to be triggerably rupturable upon the detection of a weakness in the component.

5. The device according to claim 3, wherein the component is an airframe component.

6. The device according to claim 5, wherein the conductive material comprises a conductive grid embedded in the composite laminate.

7. The device according to claim 5, wherein the conductive material comprises a fiber optic woven into a laminate material.

8. The device according to claim 5, wherein the conductive material comprises an electrically conductive material woven into a laminate material.

9. The device according to claim 5, wherein the conductive material comprises a conductive material sprayed onto a layer of fabric.

10. The device according to claim 1, wherein the monitoring module further comprises:
a printed circuit element.

11. A method of monitoring a composite laminate component, the method comprising:
providing a laminate composite component having a conductive layer sandwiched between at least two non-conductive layers;
inputting one of an electrical and an optical signal to the conductive layer;
receiving the signal after transmission through the conductive layer; and
analyzing the received signal to determine whether the component comprises a weakness.

12. The method of claim 12, wherein determining whether the component comprises a weakness includes:
determining whether there has been a change in one of the inductance and the resistance of the conductive material.

13. The method of claim 12, wherein determining whether the component comprises a weakness includes:
determining whether one of the inductance and the resistance of the conductive material falls outside a predetermined range.

14. The method of claim 12, wherein inputting the signal comprises:
continuously inputting the signal to the conductive material.

15. The method of claim 12, wherein inputting the signal comprises:
semi-continuously inputting the signal to the conductive material.

16. The method of claim 12, wherein the conductive material includes a plurality of sections and inputting the signal comprises:
inputting the signal to each of the plurality of sections of the conductive material sequentially.

17. The method of claim 11, further comprising:
if a weakness is detected, applying a sealant material to at least a weakened section of the component.

18. The method of claim 17, wherein the sealant material is located in the laminate composite component and applying the sealant material includes:
triggering a rupture of a container holding the sealant material.

19. A method of manufacturing a composite laminate airplane component having a monitoring feature, the method comprising:
providing a non-conductive first laminate layer;
providing a conductive material adjacent the first non-conductive laminate layer;
providing a second non-conductive laminate layer adjacent the conductive material, and located on the side opposite the first non-conductive laminate layer;
attaching an input to the conductive material, wherein the input is configured to input one of an electrical and an optical signal to the conductive material; attaching a detector to the conductive material, wherein the detector is configured to detect at least one transmission parameter of the conductive material based on a receipt of the input signal; and
wherein the first and second non-conductive layers are shaped to form the airplane component;

20. The method of claim 19, further comprising:
triggering the rupture of an uncured resin material comprised in the airplane component when a weakness is detected based on the at least one transmission parameter.
